(19) United States
(12) Patent Application Publication
(10) Pub. No.: US 2019/0125606 A1
(43) Pub. Date: May 2, 2019

(54) DEVICE FOR PRODUCING RHYTHMIC MOVEMENT

(71) Applicant: TUNG KENG ENTERPRISE CO., LTD., Taichung City (TW)

(72) Inventor: CHIA-YEN HUANG, Taichung City (TW)

(73) Assignee: TUNG KENG ENTERPRISE CO., LTD., Taichung City (TW)

(21) Appl. No.: 15/796,509

(22) Filed: Oct. 27, 2017

(51) Int. Cl. A61H 1/00

(52) U.S. Cl. CPC A61H 1/005; A61H 2201/1669; A61H 2203/0443; A61H 1/003

(57) ABSTRACT

A device for producing a rhythmic movement includes a base, a movable base, a first shaft, a second shaft, and a driving device. The movable base is disposed on the base, and could reciprocate in a predetermined axial direction. A first end of the first shaft is pivotally connected to a first end of the second shaft. A second end of the first shaft is pivotally disposed on the movable base. A second end of the second shaft is pivotally disposed on the base. The driving device is disposed on the base and is connected to a pivot of the first shaft and the second shaft. The driving device repeatedly drives the pivot to move between a first position and a second position, so that the movable base could reciprocate in the predetermined axial direction. Whereby, a user on the device could move rhythmically, promoting the user's metabolism and circulation.

### BACKGROUND OF THE INVENTION

### 1. Technical Field

The present invention relates generally to a health equipment, and more particularly to a device for producing a rhythmic movement.

### 2. Description of Related Art

A general bed is provided on a ground to be laid down by a user. However, when the user is in bed, a body portion contacting with the bed would be pressed under the user's weight, which may cause poor blood circulation.

For those who can act on their own, such pressure could be improved by turning over in bed. However, for those who cannot act autonomously (such as patients, those being bedridden, or those being in a persistent vegetative state), the prolonged pressure may occur bedsores.

In light of this, a swing device which could reciprocate is developed. When a user is on the swing device, a body of the user could swing along with the swing device, whereby to stimulate blood circulation. A conventional swing device, as disclosed in the Taiwan utility model patent M328860, is connected to a rotating bolt via a motor, and a sliding nut is disposed on the rotating bolt and is engaged with a sliding board, and a bearing member is disposed on the sliding board to be laid down by the user. Whereby, the bearing member could reciprocate along with the repeated forward and reverse rotation of the motor, stimulating the user's blood circulation.

In order to reciprocate the swing device, the motor thereof has to repeatedly rotate forward and reverse. However, when the motor is switched between forward and reverse rotation, an axle of the motor will temporary stop, so that the movement of the bearing member will be paused at the time that the motor is switched. As a result, the user cannot move rhythmically and stably. In all aspects, the conventional swing device still has room for improvements.

### BRIEF SUMMARY OF THE INVENTION

In view of the above, the primary objective of the present invention is to provide a device for producing a rhythmic movement, which could produce a periodic movement, facilitating the circulation of the human body.

The present invention provides a device for producing a rhythmic movement, including a base, a movable base, a first shaft, a second shaft, and a driving device. The movable base is disposed on the base, and moves relative to the base and reciprocates in a predetermined axial direction. The first shaft has a first end, and the second shaft has a first end pivotally connected to the first end of the first shaft. A second end of the first shaft is pivotally disposed on the movable base. A second end of the second shaft is pivotally disposed on the base. A pivot of the first end of the first shaft and the first end of the second shaft is located between the second end of the first shaft and the second end of the second shaft in the predetermined axial direction. The driving device is disposed on the base and is connected to the pivot of the first end of the first shaft and the first end of the second shaft, wherein the driving device repeatedly drives the pivot to move between a first position and a second position. When the pivot moves toward the first position, the second end of the first shaft is away from the second end of the second shaft in the predetermined axial direction, so that the movable base is driven to move toward a first direction in the predetermined axial direction. When the pivot moves toward the second position, the second end of the first shaft approaches to the second end of the second shaft, so that the movable base is driven to move toward a second direction in the predetermined axial direction, wherein the second direction is opposite to the first direction.

With the aforementioned design, the first shaft and the second shaft are driven by the driving device, so that the movable base could reciprocate in the predetermined axial direction, and the movable base could move rhythmically and stably. Whereby, a user on the device could move rhythmically along with the device for producing a rhythmic movement, facilitating the user's circulation and metabolism.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the device for producing a rhythmic movement of a first embodiment of the present invention;

FIG. 2 is a top view of the device of the first embodiment;

FIG. 3 is a partial enlarged view of FIG. 2;

FIG. 4 is a partial perspective view of the device of the first embodiment;

FIG. 5 is a sectional view of the device of the first embodiment;

FIG. 6 is a partial top view of the device of the first embodiment, showing the adjusting member is moved to the third position;

FIG. 7 is a partial perspective view of the device for producing a rhythmic movement of a second embodiment of the present invention;

FIG. 8 is a partial top view of the device of the second embodiment;

FIG. 9 is a partial top view of the device of the second embodiment;

FIG. 10 is a partial top view of the device for producing a rhythmic movement of a third embodiment of the present invention;

FIG. 11 is a partial top view of the device for producing a rhythmic movement of a fourth embodiment of the present invention; and

FIG. 12 is a partial top view of the device for producing a rhythmic movement of a fifth embodiment of the present invention.

### DETAILED DESCRIPTION OF THE INVENTION

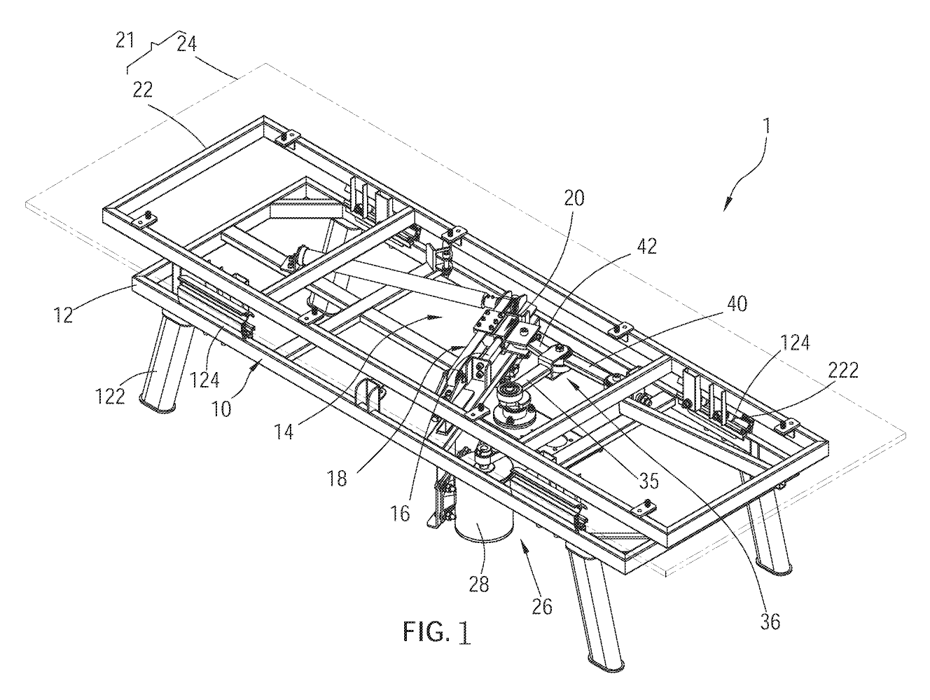

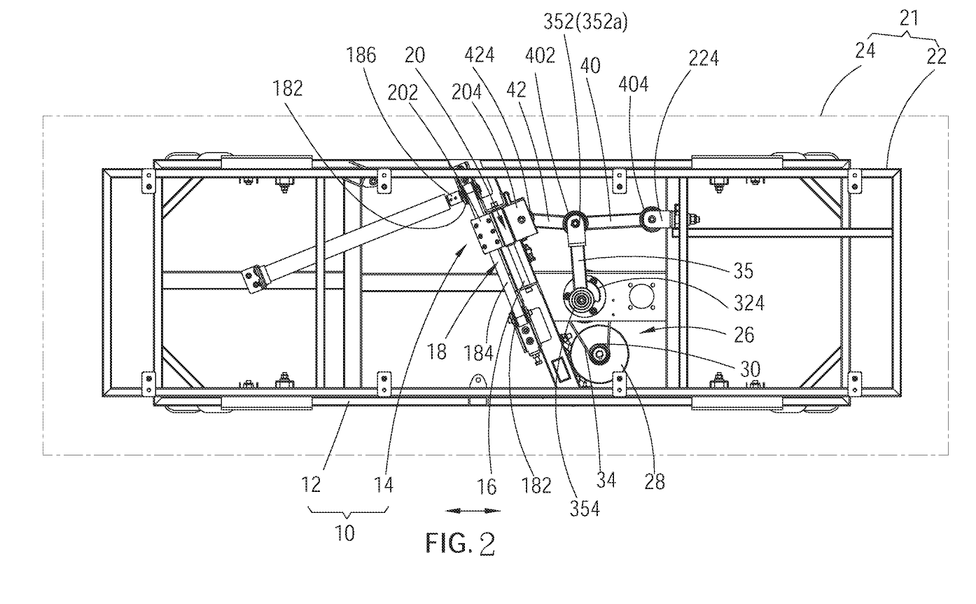

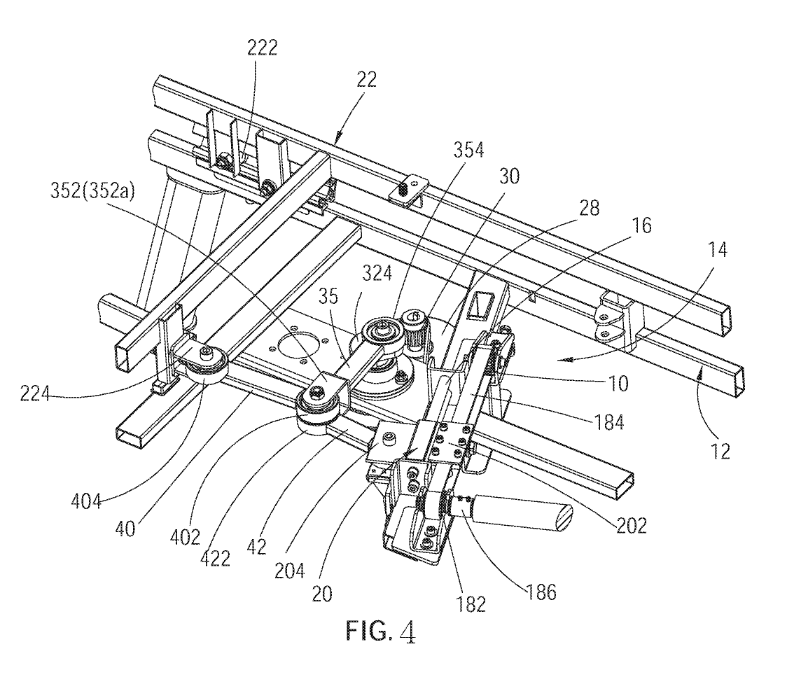

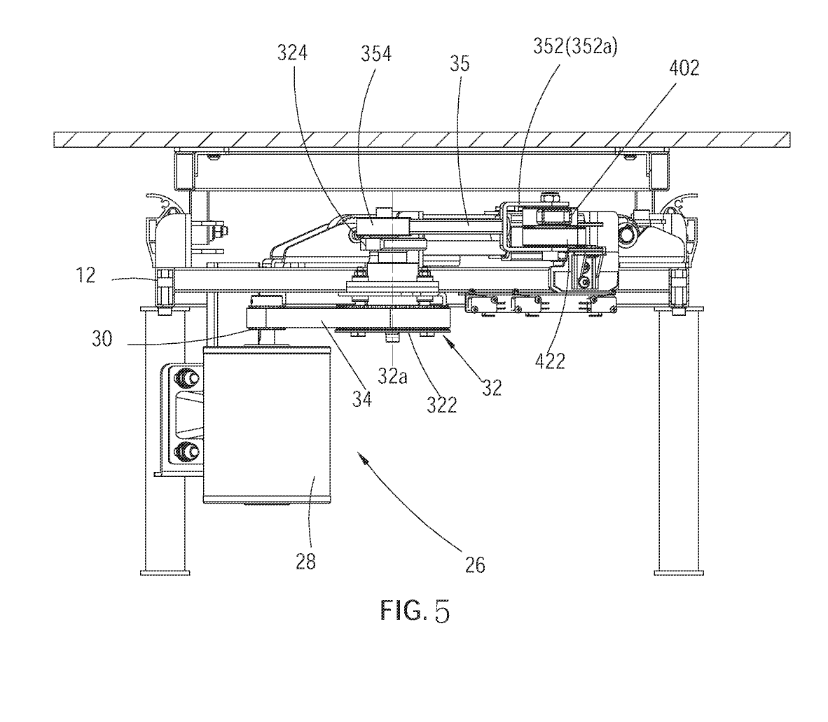

As illustrated in FIG. 1 to FIG. 6, a device for producing a rhythmic movement 1 of a first embodiment of the present invention includes a base 10, a movable base 21, a driving device 26, and a shaft assembly 36.

In the current embodiment, the base 10 includes a frame 12 and an adjusting device 14, wherein the frame 12 is long and rectangular, and has four legs 122 to be positioned on a bearing surface (such as ground). A top of the frame 12 includes a plurality of rails 124. Each of the rails 124 extends in a predetermined axial direction L. In the current embodiment, the rails 124 includes four rails 124, wherein each of the rails 124 extends in a long axial direction of the frame 12.

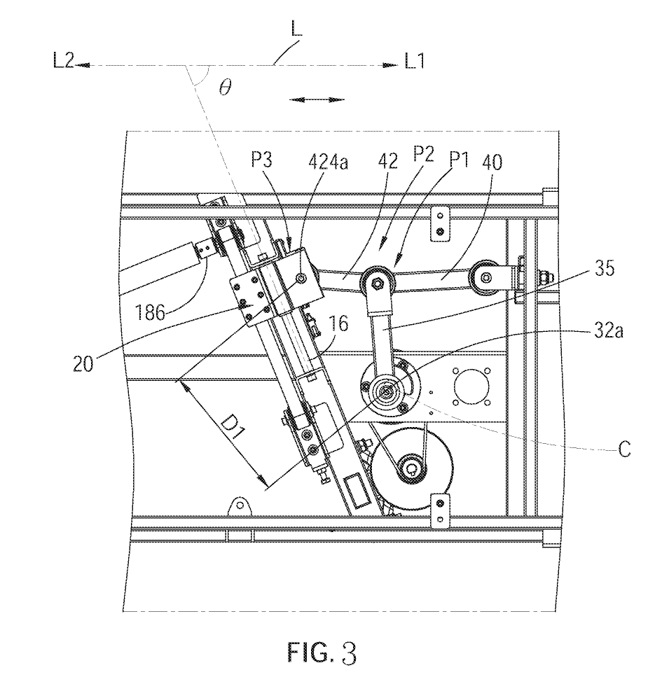

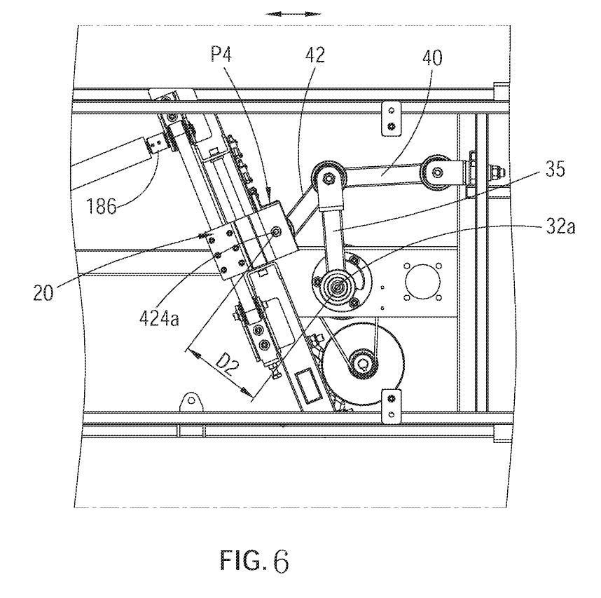

The adjusting device 14 is disposed on the frame 12, and includes at least one guiding shaft 16, a driving member 18, and an adjusting member 20. In the current embodiment, the at least one guiding shaft 16 includes two juxtaposed guiding shafts 16 from top down. There is an angle θ which is less than 90 degrees between a lone axial direction of the guiding shaft 16 and the predetermined axial direction L, wherein the driving device 26 and the shaft assembly 36 are located within an area corresponding to the angle θ. In the current embodiment, the driving member 18 includes two pulleys 182, a belt 184, and a motor 186, wherein the pulleys 182 are disposed on the frame 12 and are spaced from each other by a distance. The belt 184 fits around the pulleys 182, and are parallel to the long axial direction of the guiding shaft 16. A body of the motor 186 is fixed on the frame 12, and an axle of the motor 186 is connected to one of the pulleys 182. The adjusting member 20 fits around the guiding shafts 16 to be moved between a third position P3 shown in FIG. 3 and a fourth position P4 shown in FIG. 6 in the lone axial direction of the guiding shafts 16. The adjusting member 20 has a plate assembly 202 and a connecting frame 204 respectively on two lateral sides thereof, wherein the plate assembly 202 is fixed on the belt 184, whereby the adjusting member 20 could be driven by the motor 186 to move between the third position P3 and the fourth position P4.

The movable base 21 includes a movable frame 22 and a support plate 24 engaged with the movable frame 22. The movable frame 22 is long and rectangular, and has a plurality of wheels 222 provided at a bottom thereof, wherein the wheels 222 are respectively mounted on the rails 124 of the frame 12, whereby the movable base 21 could reciprocate relative to the base 10 in the predetermined axial direction L.

The driving device 26 is disposed on the frame 12 of the base 10, and includes a driving motor 28, a rotating member 32, and a connecting member which is a connecting shaft 35 as an example, wherein an axle of the driving motor 28 drives the rotating member 32 to rotate. In the current embodiment, a body of the driving motor 28 is disposed on the frame 12, and a first pulley 30 is disposed on the axle of the driving motor 28, wherein the axle of the driving motor 28 is perpendicular to a bottom surface of the support plate 24. The rotating member 32 is rotatably disposed on the frame 12, and includes a second pulley 322 and a rotating disk 324, wherein a diameter of the second pulley 322 is greater than a diameter of the first pulley 30, and a belt 34 is wound around the first pulley 30 and the second pulley 322. The rotating disk 324 is located above the second pulley 322 and is connected to the second pulley 322, whereby to coaxially rotate with the second pulley 322. A rotation center 32a of the rotating member 32 is parallel to the axle of the driving motor 28. The connecting shaft 35 has a first end 352 and a second end 354. In the current embodiment, the first end 352 of the connecting shaft 35 includes a connecting frame 352a. The second end 354 of the connecting shaft 35 is pivotally disposed on the rotating member 32, and is located on a side of the rotation center 32a of the rotating member 32. In other words, the second end 354 is adjacent to the rotation center 32a of the rotating member 32, and the second end 354 and the rotation center 32a are eccentric. In the current embodiment, the second end 354 of the connecting shaft 35 is pivotally disposed on the rotating disk 324.

The shaft assembly 36 includes a first shaft 40 and a second shaft 42, wherein the first shaft 40 has a first end 402, and the second shaft 42 has a first end 422. The first ends 402, 422 of the first shaft 40 and the second shaft are pivotally connected to each other, and are pivotally connected to the first end 352 of the connecting shaft 35. In the current embodiment, the first end 402 of the first shaft 40 and the first end 422 of the second shaft 42 are pivoted in the connecting frame 352a of the connecting shaft 35 via a pivot. Either of the first end 402 of the first shaft 40 or the first end 422 of the second shaft 42 is located above the first end of the other. In the current embodiment, the first end 402 of the first shaft 40 is located above the first end 422 of the second shaft 42. A second end 404 of the first shaft 40 is pivoted in a connecting frame 224 of the movable frame 22. A second end 424 of the second shaft 42 is pivotally disposed on the base 10. In the current embodiment, the second end 424 of the second shaft 42 is pivoted in the connecting frame 204 of the adjusting member 20 of the adjusting device 14. The pivot of the first end 402 of the first shaft 40 and the first end 422 of the second shaft 42 is located between the second end 404 of the first shaft 40 and the second end 424 of the second shaft 42 in the predetermined axial direction L.

When the axle of the driving motor 28 rotates, the rotating disk 324 of the rotating member 32 is driven to rotate, whereby to drive the second end 354 of the connecting shaft 35 to move along a path C in only one direction, wherein the path C is circular (as shown in FIG. 3) and is parallel to the bottom surface of the support plate 24. When the adjusting member 20 is static, the second end 424 of the second shaft 42 is located at the same position, so that the first end 352 of the connecting shaft 35 repeatedly drives the pivot of the first end 402 of the first shaft 40 and the first end 422 of the second shaft 42 to reciprocate between a first position P1 and a second position P2 shown in FIG. 3. When the pivot moves toward the first position P1, the second end 404 of the first shaft 40 is driven to move in a first direction L1 away from the second end 424 of the second shaft 42 in the predetermined axial direction L, so that the movable base 21 is driven to move toward the first direction L1 in the predetermined axial direction L. When the pivot moves toward the second position P2, the second end 404 of the first shaft 40 is driven to move in a second direction L2 approaching to the second end 424 of the second shaft 42 in the predetermined axial direction L, so that the movable base 21 is driven to move toward the second direction L2 in the predetermined axial direction L, wherein the second direction L2 is opposite to the first direction L1. With such repeated movement, the support plate 24 could produce a rhythmic movement in the predetermined axial direction L, whereby a body of a user could move rhythmically when the user is on the support plate 24, promoting the user's metabolism and circulation.

In addition, by changing a position of the adjusting member 20 via the motor 186 of the adjusting device 14, a range of the rhythmic movement could be changed.

When the motor 186 of the adjusting device 14 is controlled to move the adjusting member 20 to the third position P3, a pivot center 424a of the second end 424 of the second shaft 42 is apart from the rotation center 32a of the rotating member 32 by a first distance D1 (shown in FIG. 3). In such a case, the second end 404 of the first shaft 40 could move relative to the second end 424 of the second shaft 42 in a smaller distance (i.e., a range of the rhythmic movement is smaller), so that the movable base 21 has a first movement range in the predetermined axial direction L. When the motor 186 of the adjusting device 14 is controlled to move the adjusting member 20 to the fourth position P4, the second end 424 of the second shaft 42 is closer to the rotation center 32a of the rotating member 32, and the pivot center 424a of the second end 424 of the second shaft 42 is apart from the rotation center 32a of the rotating member 32 by a second distance D2 (shown in FIG. 6), wherein the second distance D2 is smaller than the first distance D1. In such a case, the second end 404 of the first shaft 40 could move in a greater distance than the second end 424 of the second shaft 42 does, so that the movable base 21 has a second movement range in the predetermined axial direction L, wherein the second movement range is greater than the first movement range, i.e., a range of the rhythmic movement is greater. In this way, the position of the adjusting member 20 could be adjusted to change the range of the rhythmic movement, whereby to meet various requirements. When the adjusting member 20 is at the third position P3, the slight rhythmic movement could produce a vibration performance. By gradually moving the adjusting member 20 towards the fourth position P4, the range of the rhythmic movement could be gradually increased, and the greater rhythmic movement could produce a shake performance.

However, the control of the adjusting member 20 is not limited by the motor 186 and the guiding shaft 16. In practice, the adjusting member 20 could be disposed on a different position of the frame 12 to adjust the position of the second end 424 of the second shaft 42. In addition, the adjusting device 14 could be omitted, and the second end 424 of the second shaft 42 is pivotally disposed on the frame 12 of the body 10 instead. In such a case, the movable base 21 could reciprocate in the predetermined axial direction L as well.

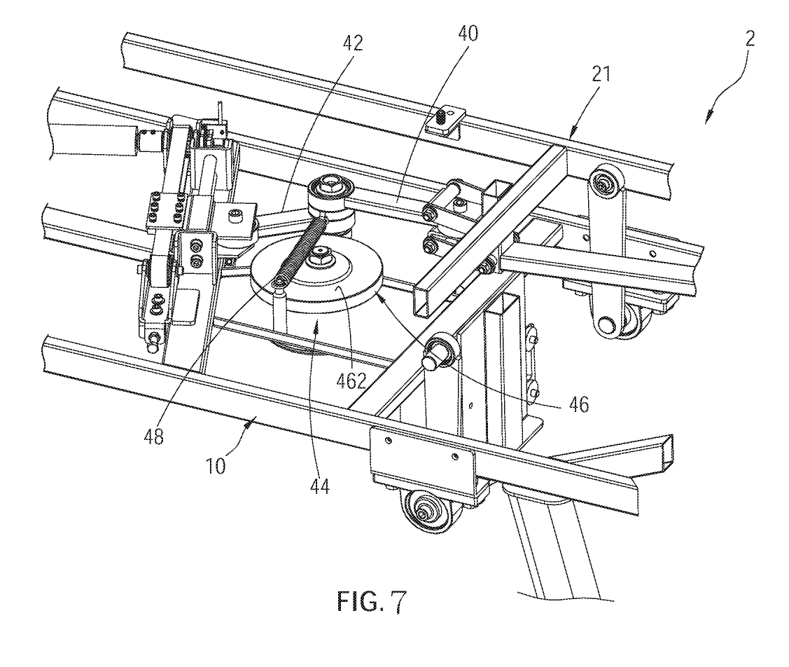

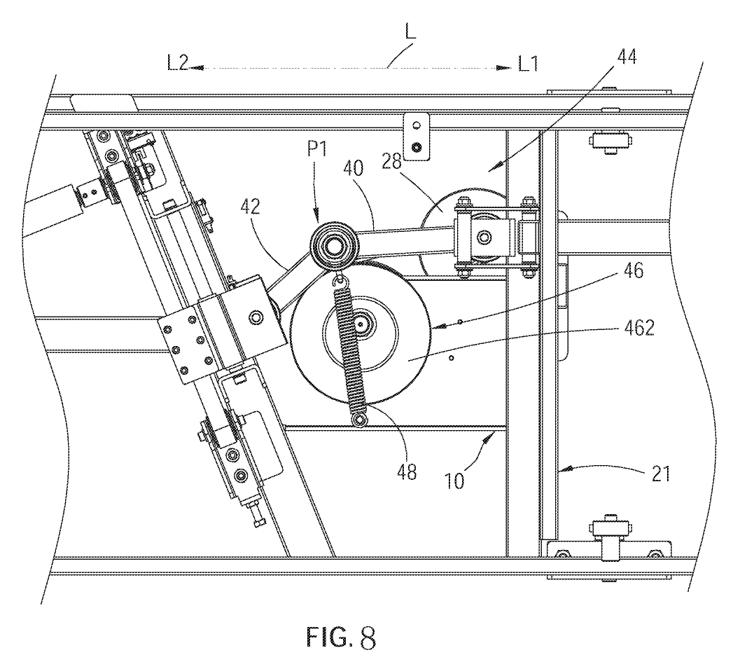

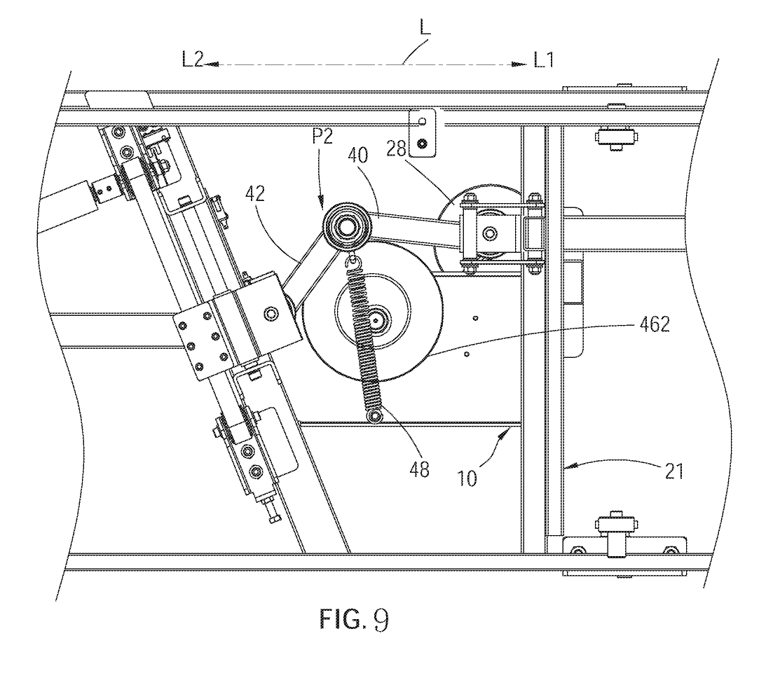

As illustrated in FIG. 7 to FIG. 9, a device for producing a rhythmic movement 2 of a second embodiment of the present invention has almost the same structure as said device of the first embodiment, except that a driving device 44 of the second embodiment includes the driving motor 28, a rotating member 46, and an elastic member 48, wherein the rotating member 46 includes an eccentric 462, which is circular, and the driving motor 28 is connected to the rotating member 46 to drive the eccentric 462 to rotate. An outer peripheral surface of the eccentric 462 abuts against the pivot of the first shaft 40 and the second shaft 42. In the current embodiment, the elastic member 48 is a spring, wherein an end of the spring is connected to the pivot of the first shaft 40 and the second shaft 42, and another end thereof is connected to the base 10. In the current embodiment, the elastic member 48 is disposed across the eccentric 462. As shown in FIG. 8 and FIG. 9, during the rotation of the eccentric 462 driven by the driving motor 28, the eccentric 462 pushes the pivot from a first position P1 to a second position P2, and the elastic member 48 is pulled to exert a force, and the first shaft 40 pushes the movable base 21 toward the first direction L1 in the predetermined axial direction L. When the elastic member 48 returns to its natural length via the force, the pivot is moved to the first position P1 again, so that the first shaft 40 pushes the movable base 21 toward the second direction L2 in the predetermined axial direction L. In this way, the movable base 21 could move rhythmically as well.

In the aforementioned embodiments, the driving device 26, 44 drives the eccentric 462 or the connecting shaft 35 to move via the driving motor 28, whereby to push the pivot of the first shaft 40 and the second shaft 42 to move between the first position P1 and the second position P2. In practice, the pivot could be driven in other ways, such as by using pneumatic cylinders or hydraulic cylinders.

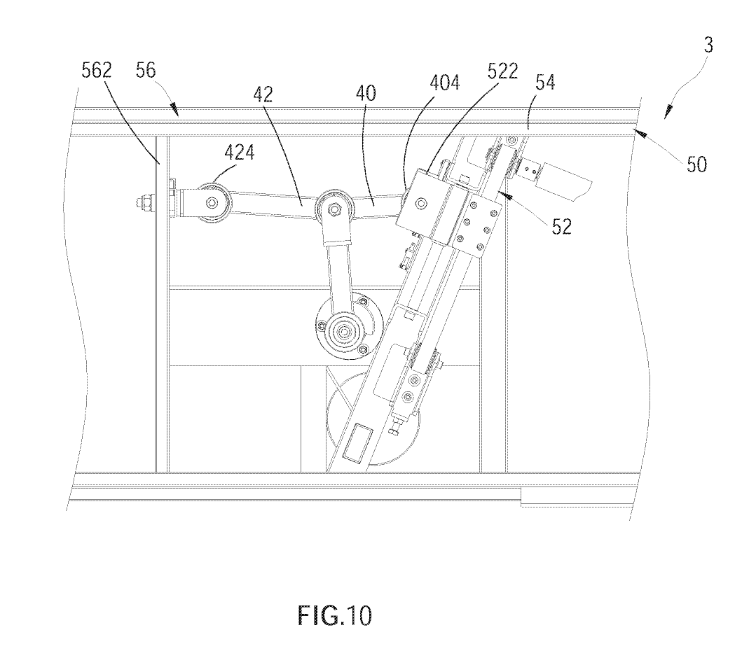

As illustrated in FIG. 10, a device for producing a rhythmic movement 3 of a third embodiment of the present invention has almost the same structure as said device of the first embodiment, except that a movable base 50 of the third embodiment includes an adjusting device 52 which is engaged with a movable frame 54. The second end 404 of the first shaft 40 is pivotally connected to an adjusting member 522 of the adjusting device 52. The second end 424 of the second shaft 42 is pivotally connected to a frame 562 of a base 56. By changing the position of the adjusting member 522, a range of the rhythmic movement of the movable base 50 could be changed as well. The action of the adjusting device 52 is the same as that of the first embodiment, thus we are not going to describe in details herein.

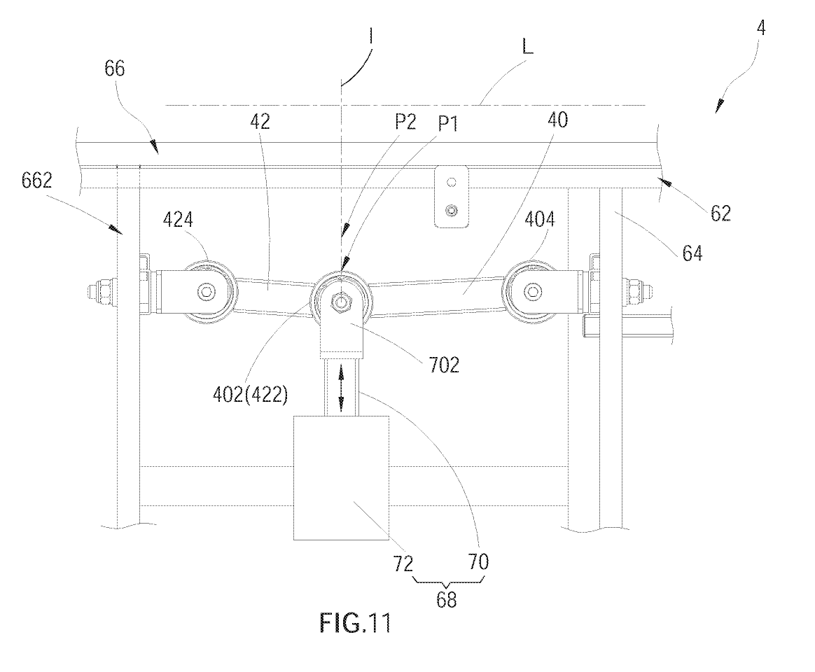

As illustrated in FIG. 11, a device for producing a rhythmic movement 4 of a fourth embodiment of the present invention has almost the same structure as said device of the aforementioned embodiments, except that the second end 404 of the first shaft 40 is pivotally connected to a movable frame 64 of a movable base 62, and the second end 424 of the second shaft 42 is pivotally connected to a frame 662 of a base 66. A driving device 68 of the fourth embodiment includes a driving member 72 and a connecting member which is a connecting shaft 70 as an example. The connecting shaft 70 is connected to the driving member 72. A first end 702 of the connecting shaft 70 is pivotally connected to the first end 402 of the first shaft 40 and the first end 422 of the second shaft 42. The driving member 72 is adapted to drive the connecting shaft 70 to extend outward and inward in an axial direction I which intersects the predetermined axial direction L. Whereby, the connecting shaft 70 could reciprocate in a predetermined distance, so that the pivot of the first shaft 40 and the second shaft 42 could be driven to move between a first position P1 and a second position P2, and the movable base 62 could move rhythmically as well. In the current embodiment, the driving member 72 could be pneumatic cylinders or hydraulic cylinders. However, the driving member is not limited by the aforementioned design. In addition, the driving member 72 could be an element which is controllable to change the predetermined distance, such as a pneumatic cylinder or a hydraulic cylinder that can adjust the movement distance. In this way, when the predetermined distance is greater, the range of the rhythmic movement of the movable base 62 is greater, and vice versa. In other words, the predetermined distance is directly proportional to a distance that the movable base 62 reciprocates in the predetermined axial direction L. In this way, the connecting shaft 70 and the driving member 72 could be used as the adjusting device.

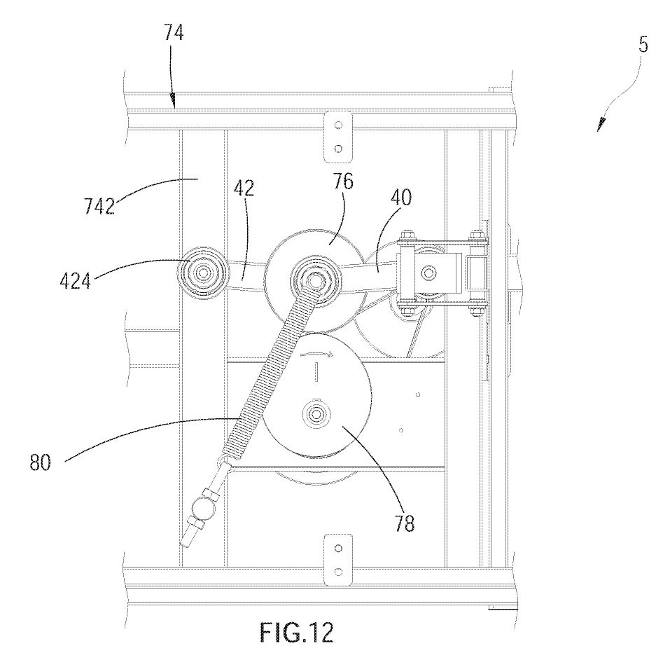

As illustrated in FIG. 12, a device for producing a rhythmic movement 5 of a fifth embodiment of the present invention has almost the same structure as said device of the second embodiment, except that the adjusting device is omitted in the current embodiment, and the second end 424 of the second shaft 42 is pivotally disposed on a frame 742 of a base 74. The pivot of the first end 402 of the first shaft 40 and the first end 422 of the second shaft 42 has a circular disc 76. An outer peripheral surface of an eccentric 78 abuts against an outer peripheral surface of the circular disc 76. An end of an elastic member 80 is connected to the pivot of the first end 402 of the first shaft 40 and the first end 422 of the second shaft 42, and another end thereof is connected to the frame 742 of the base 74. In this way, the movable base could move rhythmically as well.

In conclusion, the device for producing a rhythmic movement of the present invention drives the shaft assembly via the driving device, so that the movable base could reciprocate in the predetermined axial direction, and the movable base could move rhythmically and stably. Whereby, a user on the device could move rhythmically, promoting the user's metabolism and circulation. The device for producing a rhythmic movement of the present invention could be applied to beds, seats, cushions and other equipment for people to rely on or lie down.

It must be pointed out that the embodiments described above are only some preferred embodiments of the present invention. All equivalent structures which employ the concepts disclosed in this specification and the appended claims should fall within the scope of the present invention.

What is claimed is:

1. A device for producing a rhythmic movement, comprising:
a base;
a movable base, which is disposed on the base, wherein the movable base moves relative to the base and reciprocates in a predetermined axial direction;
a first shaft and a second shaft, wherein the first shaft has a first end, and the second shaft has a first end pivotally connected to the first end of the first shaft; a second end of the first shaft is pivotally disposed on the movable base; a second end of the second shaft is pivotally disposed on the base; a pivot of the first end of the first shaft and the first end of the second shaft is located between the second end of the first shaft and the second end of the second shaft in the predetermined axial direction; and
a driving device which is disposed on the base and is connected to the pivot of the first end of the first shaft and the first end of the second shaft, wherein the driving device repeatedly drives the pivot to move between a first position and a second position; when the pivot moves toward the first position, the second end of the first shaft is away from the second end of the second shaft in the predetermined axial direction, so that the movable base is driven to move toward a first direction in the predetermined axial direction; when the pivot moves toward the second position, the second end of the first shaft approaches to the second end of the second shaft, so that the movable base is driven to move toward a second direction in the predetermined axial direction, wherein the second direction is opposite to the first direction.

2. The device of claim 1, wherein the base comprises a frame and an adjusting device disposed on the frame; the adjusting device comprises an adjusting member, and the second end of the second shaft is pivotally disposed on the adjusting member; the adjusting member moves between a third position and a fourth position; when the adjusting member moves to the third position, the movable base has a first movement range in the predetermined axial direction; when the adjusting member moves to the fourth position, the movable base has a second movement range in the predetermined axial direction, wherein the second movement range is greater than the first movement range.

3. The device of claim 1, wherein the movable base comprises a movable frame and an adjusting device disposed on the movable frame; the adjusting device comprises an adjusting member, and the second end of the first shaft is pivotally disposed on the adjusting member; the adjusting member moves between a third position and a fourth position; when the adjusting member moves to the third position, the movable base has a first movement range in the predetermined axial direction; when the adjusting member moves to the fourth position, the movable base has a second movement range in the predetermined axial direction, wherein the second movement range is greater than the first movement range.

4. The device of claim 2, wherein the adjusting device comprises a guiding shaft and a driving member; the adjusting member is movably disposed on the guiding shaft, and moves between the third position and the fourth position in a lone axial direction of the guiding shaft; the driving member is connected to the adjusting member, and is adapted to drive the adjusting member to move.

5. The device of claim 4, wherein there is an angle which is less than 90 degrees between the lone axial direction of the guiding shaft and the predetermined axial direction

6. The device of claim 3, wherein the adjusting device comprises a guiding shaft and a driving member; the adjusting member is movably disposed on the guiding shaft, and moves between the third position and the fourth position in a lone axial direction of the guiding shaft; the driving member is connected to the adjusting member, and is adapted to drive the adjusting member to move.

7. The device of claim 6, wherein there is an angle which is less than 90 degrees between the lone axial direction of the guiding shaft and the predetermined axial direction.

8. The device of claim 1, wherein the driving device comprises a driving motor, a rotating member, and a connecting member; an axle of the driving motor drives the rotating member to rotate; a first end of the connecting member is pivotally connected to the first end of the first shaft and the first end of the second shaft; a second end of the connecting member is pivotally disposed on the rotating member, and is located on a side of a rotation center of the rotating member; the second end of the connecting member is driven by the rotating member to move along a path, so that the connecting member drives the second end of the first shaft to repeatedly approach to and recede from the second end of the second shaft in the predetermined axial direction, whereby to drive the movable base to reciprocate in the predetermined axial direction.

9. The device of claim 1, wherein the driving device comprises a connecting member and a driving member; the connecting member is connected to the driving member, and an end of the connecting member is pivotally connected to the first end of the first shaft and the first end of the second shaft; the driving member drives the connecting member to reciprocate in a predetermined distance in an axial direction which intersects the predetermined axial direction, so that the pivot is driven to repeatedly move between the first position and the second position.

10. The device of claim 9, wherein the driving member is controllable to change the predetermined distance, and the predetermined distance is directly proportional to a distance that the movable base reciprocates in the predetermined axial direction.

11. The device of claim 1, wherein the driving device comprises a driving motor, an eccentric, and an elastic member; an axle of the driving motor drives the eccentric to rotate; the eccentric abuts against the pivot; an end of the elastic member is connected to the pivot, and another end thereof is connected to the base; when the eccentric rotates, the pivot is pushed from the first position to the second position, and is pulled by the elastic member to return to the first position.

12. The device of claim 11, wherein the elastic member is disposed across the eccentric.
